(19) United States
(12) Patent Application Publication
(10) Pub. No.: US 2023/0108607 A1
(43) Pub. Date: Apr. 6, 2023

(54) INTEGRATED PACKAGING METHOD FOR PORTABLE ENERGY STORAGE DEVICE

(71) Applicant: Shenzhen Xinda New Energy Technology Co., Ltd., Shenzhen (CN)

(72) Inventor: Dongliang LIAO, Shenzhen (CN)

(73) Assignee: Shenzhen Xinda New Energy Technology Co., Ltd., Shenzhen (CN)

(21) Appl. No.: 18/079,003

(22) Filed: Dec. 12, 2022

Related U.S. Application Data
(63) Continuation of application No. PCT/CN2021/090423, filed on Apr. 28, 2021.

(30) Foreign Application Priority Data
Jun. 16, 2020 (CN) 202010549750.X
Jan. 18, 2021 (CN) 202110063805.0

(51) Int. Cl. H01M 10/04

(52) U.S. Cl. CPC H01M 10/049

(57) ABSTRACT

Disclosed is an integrated packaging method for a portable energy storage device, the method comprising the following steps: 1. preparing a roll cell (1) or a stacked cell (1); and 2. placing the prepared roll cell (1) or stacked cell (1) in a mold, injecting a precursor of an encapsulating agent for carrying out encapsulation, injecting an electrolyte, and completing the encapsulation after the precursor is polymerized.

### CROSS-REFERENCE TO RELATED APPLICATIONS

The application claims priority to Chinese patent application No. 202010549750.X, filed on Jun. 16, 2020; No. 202110063805.0, filed on Jan. 18, 2021, the entire contents of which are incorporated herein by reference.

### TECHNICAL FIELD

The present disclosure relates to the technical field of energy storage devices, and in particular to an integrated packaging method for a portable energy storage device.

### BACKGROUND

Electricity has become an indispensable part of modern human civilization after arrival of the Electrical Age in the 20th century. Various energy storage devices have been invented for convenient electricity storage, for example, dry batteries, nickel-cadmium batteries, nickel-metal hydride batteries, and lithium batteries. After entering the 21st century, the energy storage devices are developed from only supplying power to electronic components into consumer batteries (the energy storage devices applied to consumer electronic components), power batteries and energy storage batteries. With the development of society, there are more and more requirements for performance of the energy storage devices. Specifically, in the field of consumer electronics, portable electronic components have been playing an increasingly important role in human life. Therefore, it is desirable that the energy storage devices have good flexibility, for example, a band from MIUI, a smartwatch from Apple, smart clothing and various headsets. At present, these electronic devices arc all powered using traditional lithium batteries. However, currently used traditional lithium batteries can only be made smaller in order to meet the performance requirements, resulting in the very short standby time and frequent charging needs of portable electronics. (At present, these electronic devices are powered by traditional lithium batteries. In order to meet the performance requirements, traditional batteries can only be made smaller. The resulting impact is that these portable electronic components have a very short standby time and need to be charged frequently.) In the field of power batteries, the lithium batteries, the nickel-hydrogen batteries and lead acid batteries are used as the power batteries at present. Due to the particularity of the usage scenarios, power batteries have high requirements of the heat dissipation, water resistance, flame retardancy and safety of the battery, thus packaging method that can prepare energy storage devices which satisfy these requirements are in urgent need. (Therefore, packaging methods that can prepare energy storage devices with good flexibility, heat dissipation, water resistance, and flame retardancy are in urgent need.)

Current commercial batteries are generally packaged in four packaging methods: cylindrical, square, button and soft. Packaging materials including steel shells, aluminum shells and aluminum-plastic films are used to encapsulate the energy storage devices. However, the heat dissipation and flame retardancy of batteries packaged in steel and aluminum shells are average. Therefore, battery system of the new energy vehicles (NEVs) that currently use lithium batteries packaged in steel and aluminum shells as power batteries has poor heat dissipation performance and needs to be equipped with a complex heat dissipation system. In addition, spontaneous combustion events often occur. Besides, additional waterproof materials are required for lithium batteries packaged in steel shells, aluminum shells, and aluminum-plastic films to work as power batteries.

Among these four kinds of encapsulation methods, the batteries prepared in cylinder, square, and button type do not have flexibility at all, while the batteries prepared by pouch-type encapsulation may be curved under the specific conditions (the thickness of the battery is very thin, preferably less than 1 mm.). However, the ultra-thin flexible battery prepared by this packaging method has several key drawbacks, including 1) the capacity of the battery is low, generally less than 100 mAh: 2) the specific surface area of the battery is large; 3) the aluminum-plastic film of high-quality materials cannot release the stress in time, hence a stress concentration area will be formed on the surface, which would eventually cause a short circuit of the battery and cause a safety accident. In addition to the thin pouch-type battery having the flexibility, a flexible battery pack may further be prepared in another way: first, the flexible casing is prepared with flexible materials, and then the battery pack is assembled into the specific position reserved by the flexible casing. Finally glue is utilized to seal the battery pack. For example, the patents with patent publication numbers of CN111129383A and CN102544574A reported preparation of flexible shells by high-temperature injection molding. However, the battery prepared with this way has the following several disadvantages: first, the production cost of the battery is evidently increased which is higher than that of batteries with the same capacity; second, this method is not conducive to automated large-scale production; Third, the battery prepared by this method has lower volume/mass energy density due to the addition of ineffective materials

### SUMMARY

The present disclosure aims at solving the technical problem of providing a novel encapsulation process for an energy storage device, so as to solve the problems of poor waterproofness, poor flexibility, poor fire resistance and ordinary heat dissipation performance of the current energy storage device caused by encapsulation with a steel shell, an aluminum shell and an aluminum-plastic film and improve the encapsulation efficiency at the same time.

The present disclosure solves the above technical problem by virtue of following technical means:

An integrated packaging method for a portable energy storage device, including the following steps:

(1) preparing a roll cell or a stacked cell, specifically, coating a positive electrode current collector with a positive electrode active material, coating a negative electrode current collector with a negative electrode active material, carrying out rolling and drying to prepare a positive electrode sheet and a negative electrode sheet, and sequentially stacking the prepared positive electrode sheet, a solid electrolyte and the negative electrode sheet to form a stacked cell A; or sequentially stacking the prepared positive electrode sheet, a diaphragm and the negative electrode sheet to form a stacked cell B or to be curled to form a roll cell B;

(2) placing the prepared roll cell B or stacked cell B in a mold, injecting a precursor of an encapsulating agent for carrying out encapsulation, injecting an electrolyte, obtaining a cell after the precursor is polymerized, and then completing the encapsulation;

or placing the prepared stacked cell A in the mold, injecting the precursor of the encapsulating agent for carrying out encapsulation, obtaining a cell after the precursor is polymerized, and then completing the encapsulation;

or encapsulating the prepared roll cell B or stacked cell B with the aluminum-plastic film, the aluminum shell or the steel shell, injecting an electrolyte, then using the precursor of the encapsulating agent for carrying out encapsulation again to obtain the cell, and then completing the encapsulation;

or encapsulating the prepared stacked cell A with the aluminum-plastic film, the aluminum shell or the steel shell, then using the precursor of the encapsulating agent for carrying out encapsulation again to obtain the cell, and then completing the encapsulation.

The encapsulating material includes one or more of resin, silica gel and rubber, wherein the resin includes thermosetting resin, and the thermosetting resin includes epoxy resin or polydimethylsiloxane; or the encapsulating agent includes a photocurable material; or the encapsulating agent includes a photoinitiator and an encapsulating material.

The present disclosure has the beneficial effects that: by encapsulating the roll cell and the stacked cell with the packaging method in the present disclosure, the energy storage device may have very good waterproof effect; and a stress generated during each curve may further be released in time, so that a short circuit due to stress concentration in the bending process cannot be caused, and waterproof energy storage devices with arbitrary shape and capacity may be made.

As a battery is treated at a temperature exceeding 150° C. for a long time, the battery may have a rapid performance degradation and then is in failure, and this high-temperature failure is irreversible. The present disclosure may encapsulate the energy storage device with the encapsulating agent at a normal temperature, so that the cost of the energy storage device can be effectively lowered, and the performance of the energy storage device cannot be destroyed during the encapsulation.

The present disclosure belongs to the encapsulation technology for the energy storage devices, assembly line work is employed in the industry at present, and it requires a dozen workers for the productivity of ten thousand for one assembly line each day. Compared with the packaging method in the prior art, the packaging method of the present disclosure only requires 5 persons, with the productivity reaching 50 thousand or above.

For the energy storage device with a same capacity, the encapsulated battery is higher in energy density, is lower in cost and is safer. Due to the use of the ultrathin flexible battery made by the aluminum-plastic film, the structure of the battery may be destroyed due to stress concentration in the curving process, and then the short circuit of the battery is induced; however, the encapsulating material in the present disclosure may relieve the released stress, so as to solve such problem; the energy density of the battery may reach 300 Wh/kg or above; mass production of the energy storage devices is facilitated at the same time; and the production cost is lowered.

The present disclosure may further be applied to the field of battery encapsulation of the traditional lithium batteries, for example, encapsulation of the batteries and encapsulation of mobile power supplies.

Preferably, the obtained cell is fixed to a printed circuit board (PCB), the PCB is placed in the mold, and then the precursor of the encapsulating agent is continuously employed for packaging the cell.

The present disclosure has the beneficial effects that: the snap process during the encapsulation of the energy storage device such as the mobile power supply is the longest time consuming process and can be finished by generally requiring mans in the prior art; and devices on the PCB are prone to being damaged by static electricity in the manual operation process, so that the yield of the mobile power supplies is low. By using the integrated packaging method of the present disclosure, after the cell is fixed to the PCB, the encapsulation in the unmanned contact process may be employed, so that the production efficiency is greatly improved; the labor force is saved; and this labor intensive industry is changed into the technology-intensive industry.

Due to reduction in manual contact, the possibility of damages with the static electricity is greatly lowered, and the yield of the energy storage devices is significantly increased. The encapsulating material is prone to being separated in the late period; the cell may be recycled and reused; and then the problem of plastic pollution caused by the traditional packaging method may be solved.

Preferably, the thermosetting resin further includes polymethyl methacrylate, polycarbamate, urea resin, melamine-formaldehyde resin, polyurethane and polyimide.

Preferably, the rubber includes one-component room temperature vulcanized silicone rubber, double-component condense type room temperature vulcanized silicone rubber, double-component addition type room temperature vulcanized silicone rubber, one-component room temperature vulcanized and cyclized rubber, double-component room temperature vulcanized and cyclized rubber and double-component room temperature vulcanized ethylene propylene rubber.

Preferably, the encapsulating agent further includes one or more of a coloring agent, a fire retardant, a toughening agent, an antioxidant, an antistatic agent, a foaming agent and a filler.

Preferably, the coloring agent includes an inorganic coloring agent and an organic coloring agent.

Preferably, the inorganic coloring agent includes titanium dioxide, ferric oxide, zinc oxide, chromate, tin salt, mercury or cadmium.

Preferably, the organic coloring agent includes carbon black, an azo pigment, phthalocyanine, quinalones, isoindolone, anthraquinone or thioindigo.

Preferably, the fire retardant includes an organic fire retardant or an inorganic fire retardant.

Preferably, the inorganic fire retardant includes aluminum hydroxide, magnesium hydroxide or zinc borate.

Preferably, the organic fire retardant includes one or more of trimethyl phosphate (TMP), triethyl phosphate (TEP), methyl difluoroacetate (MFA) and ethyl difluoroacetate (EFA) in trimethyl phosphate (TMP), triethyl phosphate (TEP), methyl difluoroacetate (MFA) and ethyl difluoroacetate (EFA).

Preferably, the toughening agent includes polyester fibers (terylene), polyamide fibers (chinlon or nylons), polyvinyl alcohol fibers (vinylon), polyacrylonitrile fibers (acrylic fibers), polypropylene fibers (polypropylene) or polyvinyl chloride fibers (chloro fibers).

Preferably, the antioxidant includes dilauryl thiodipropionate, propanoic acid n-octadecyl alcohol ester, alkylphenol thioether and phenyl salicylate.

Preferably, the antistatic agent includes trihydroxyethyl methyl quaternary ammonium methyl sulfate, dimethyl octadecyl ammonium nitrate, a polyethylene glycol-methacrylic acid copolymer, polyether ester amide, polyetherester acetamide, polyoxyethylene and an epoxypropane copolymer.

Preferably, the foaming agent includes an organic foaming agent and an inorganic foaming agent.

Preferably, the organic foaming agent includes azodicarbonamide, azobisisobutyro-nitrile (AlBN), butane, pentane, petroleum, ether, difluorodichloromethane, a sulfohydrazide compound and a nitro compound.

Preferably, the inorganic foaming agent includes calcium carbonate, magnesium carbonate, sodium bicarbonate and the carbon black.

Preferably, a surfactant includes linear alkylbenzene sulfonate (LAS), fatty alcohol polyoxyethylene lauryl ether sulfate sodium (AES), fatty alcohol polyoxyethylene lauryl ether sulfate ammonium (AESA), sodium lauryl sulfate (K12 or SDS), lauroyl glutamine, nonylphenol ethoxylate (10) ester (TX-10), diethanolamide (6501) glycerol monostearate, lignosulfonate, heavy alkylbenzene sulfonate, alkane sulfonate (petroleum sulfonate), alkyl polyether (PO-EO copolymer) and fatty alcohol polyoxyethylene (3) ether (AEO-3).

Preferably, the plasticizer includes phthalate esters, fatty dibasic acid esters, phosphate esters and chlorinated paraffin.

Preferably, the phthalate esters include demethyl phthalate (DMP), diethyl phthalate (DEP), di-n-butyl ortho-phthalate (DBP), dioctyl phthalate (DOP), butyl benzyl phthalate (BBP), di-2-ethylhexyl phthalate (DEHP), dioctyl phthalate (DOP) and diisononyl phthalate (DINP).

Preferably, the filler includes clay, silicate, talc and carbonate.

Preferably, the encapsulating agent, in which the precursor is charged, is placed in vacuum for treatment for 0-720 min and then conducts reaction for 1-240 min at 25-100° C.

Preferably, a preparation method for the positive electrode active material includes the following steps: mixing a positive electrode material, an adhesive, a conductive agent and a solvent to prepare the positive electrode active material.

Preferably, the solvent is N-methylpyrrolidone (NMP).

Preferably, a preparation method for the negative electrode active material includes the following steps: mixing a negative electrode material, an adhesive, a conductive agent and a solvent to prepare the negative electrode active material.

Preferably, the solvent is deionized water.

Preferably, the positive electrode material includes one or more of lithium iron phosphate (LFP), lithium cobalt oxide (LCO), lithium manganate (LMO), nickel-cobalt-manganese ternary positive electrode material (NCM) and nickel-cobalt-aluminum ternary positive electrode material (NCA).

Preferably, the negative electrode material includes one or more of synthetic graphite, natural graphite, a mesocarbon microbead, a carbon-silicon negative electrode and lithium titanate.

The present disclosure has the advantages that: by encapsulating the roll cell and the stacked cell with the packaging method of the present disclosure, the energy storage device may have very good waterproof effect; and a stress generated during each curve may further be released in time, so that a short circuit due to stress concentration in the bending process cannot be caused, and waterproof energy storage devices with arbitrary shape and capacity may be made.

As a battery is treated at a temperature exceeding 150° C. for a long time, the battery may have a rapid performance degradation and then is in failure, and this high-temperature failure is irreversible. The present disclosure encapsulates the energy storage device with the encapsulating agent at a normal temperature, so that the cost of the energy storage device can be effectively lowered, and the performance of the energy storage device cannot be destroyed during the encapsulation.

Compared with the packaging method in the prior art, by using the packaging method of the present disclosure, for the energy storage device with a same capacity, the encapsulated battery is higher in energy density, is lower in cost and is safer. Due to the use of the ultrathin flexible battery made by the aluminum-plastic film, the structure of the battery may be destroyed due to stress concentration in the curving process, and then the short circuit of the battery is induced; however, the encapsulating material in the present disclosure may relieve the released stress, so as to solve such problem; the energy density of the battery may reach 300 Wh/kg or above; mass production of the energy storage devices is facilitated at the same time; and the production cost is lowered.

The present disclosure may further be applied to battery pack of the traditional lithium batteries, for example, encapsulation of the batteries and encapsulation of mobile power supplies.

The snap process during the encapsulation of the energy storage device such as the mobile power supply is the longest time consuming process and can be finished by generally requiring mans in the prior art; and devices on the PCB are prone to being damaged by static electricity in the manual operation process, so that the yield of the mobile power supplies is low. By using the integrated packaging method of the present disclosure, after the cell is fixed to the PCB, the encapsulation in the unmanned contact process may be employed, so that the production efficiency is greatly improved; the labor force is saved; and this labor intensive industry is changed into the technology-intensive industry.

Due to reduction in manual contact, the possibility of damages with the static electricity is greatly lowered, and the yield of the energy storage devices is significantly increased. The encapsulating material is prone to being separated in the late period; the cell may be recycled and reused; and then the problem of plastic pollution caused by the traditional packaging method may be solved.

### BRIEF DESCRIPTION OF DRAWINGS

FIG. 1 is a front view of a battery in embodiments 1-3 of the present disclosure.

FIG. 2 is a schematic structural diagram of stacking a positive electrode sheet, a diaphragm and a negative electrode sheet in embodiments 1-3 of the present disclosure.

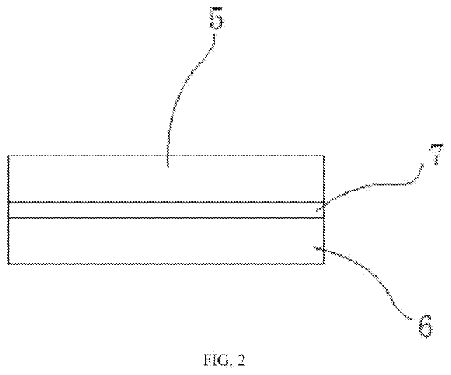

FIG. 3 is a schematic structural diagram of a battery in embodiment 26 of the present disclosure.

FIG. 4 is a schematic structural diagram of a battery in embodiment 27 of the present disclosure.

In the drawings: stacked cell or roll cell 1; encapsulating material 2; positive electrode 3; negative electrode 4; positive electrode sheet 5; negative electrode sheet 6; diaphragm 7.

### DETAILED DESCRIPTION OF THE EMBODIMENTS

In order to make objectives, technical solutions, and advantages of the embodiments of the present disclosure clearer, the technical solutions in the embodiments of the present disclosure are described clearly and completely in the following with reference to the embodiments of the present disclosure. Apparently, the described embodiments are only part rather than all of the embodiments of the present disclosure. Based on the embodiments of the present disclosure, all the other embodiments obtained by those of ordinary skill in the art without inventive effort are within the scope of the present disclosure.

Test materials, reagents and the like used in the following embodiments may be commercially available, unless otherwise noted.

If the specific technologies and conditions arc not noted in the embodiments, the test materials, reagents and the like may all comply with the technologies or conditions described in the literatures in the art or the instructions of products.

Polycarbamate A, polycarbamate B, room temperature vulcanized silicone rubber A and room temperature vulcanized silicone rubber B are purchased from Dongguan Juhong New Material Technology Co., Ltd.

Titanium dioxide as an inorganic coloring agent. phthalocyanine as an organic coloring agent, aluminum hydroxide as an inorganic fire retardant and trimethyl phosphate as an organic fertilizer arc purchased from Beijing J&K Scientific Co., Ltd.

### Embodiment 1

An integrated packaging method for a portable energy storage device includes the following steps:

(1) Preparation of a positive electrode active material: in a glove box with the protection of argon, with lithium cobalt oxide as a positive electrode material, 47.5 g of the lithium cobalt oxide (LCO), 1 g of polyvinylidene fluoride (PVDF), 1 g of carbon black (SP), 0.5 g of a carbon nanotube (CNT) and 25 g of N-methylpyrrolidone (NMP) were weighed for mixing and dispersion, and then the positive electrode active material was prepared.

(2) Preparation of a negative electrode active material: in a glove box with the protection of argon, with synthetic graphite as a negative electrode, 23.5 g of the synthetic graphite, 0.375 g of calcium carboxymethylcellulose (CMC-Na), 0.625 g of butadiene styrene rubber (SBR), 0.5 g of the carbon black (SP) and 12.5 g of deionized water for mixing and dispersion, and then the negative electrode active material was prepared.

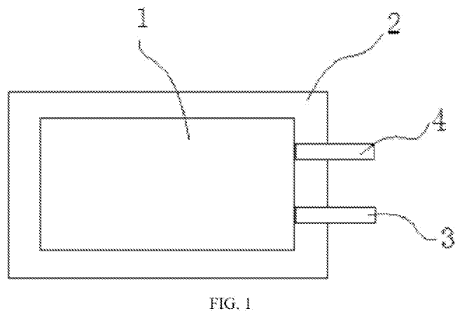

(3) An aluminum foil was coated with the prepared positive electrode active material with a coating quantity of 40 mg/m2, a copper foil was coated with the negative electrode active material with a coating quantity of 20 mg/m2, and the aluminum foil and the copper foil were baked for 24 h at 80° C. and then rolled at 4.5 Mpa and 4.8 Mpa respectively to prepare a positive electrode sheet 5 and a negative electrode sheet 6. As shown in FIG. 1, a stack formed by the positive electrode sheet 5, a diaphragm 7 and the negative electrode sheet 6 is sequentially curled to form a roll cell 1, with the positive electrode sheet 5 being in the inner layer and the negative electrode sheet 6 being in the outer layer; the positive electrode sheet 5 coated with the positive electrode active material faces one side of the diaphragm 7; the negative electrode sheet 6 coated with the negative electrode active material faces the other side of the diaphragm 7; and then a positive electrode and a negative electrode of the battery are mounted, wherein the mounting manners of the positive electrode and the negative electrode of the battery belong to the prior art.

(4) 15 g of silica gel A and 15 g of silica gel B were mixed to prepare a mixed liquid as a precursor of an encapsulating agent; the roll cell in step (3) was placed in a mold; an opening was reserved for liquid injection during the encapsulation of the encapsulating agent; the mold was placed in a vacuum environment for 30 min and then taken out after 30 min for still standing for 4 h; after still standing was finished, the liquid was injected for a battery with the injection quantity of 1.6 g (wherein an injected electrolytic solution contains 1 mol/L lithium hexafluorophosphate (LiPF₆) as lithium salt and ethylene carbonate (EC) and dimethyl carbonate (DMC) as a solvent, and a volume ratio of the ethylene carbonate (EC) and the dimethyl carbonate (DMC) is 1 to 1); and after liquid injection, the same encapsulating agent was employed for carrying out secondary encapsulation on the opening of the battery. The encapsulated battery is shown in FIG. 1.

(5) The battery made in step (4) was subjected to still standing for 24 h in an ageing room at 25° C.; and after ageing, formation was carried out on the battery, wherein a formation technology in this embodiment belongs to the prior art.

### Embodiment 2

An integrated packaging method for a portable energy storage device includes the following steps:

(1) Preparation of a positive electrode active material: in a glove box with the protection of argon, with lithium iron phosphate as a positive electrode material. 47.5 g of the lithium iron phosphate (LFP), 1 g of polyvinylidene fluoride (PVDF), 1 g of carbon black (SP), 0.5 g of a carbon nanotube (CNT) and 25 g of N-methylpyrrolidone (NMP) were weighed for mixing and dispersion, and then the positive electrode active material was prepared.

(2) Preparation of a negative electrode active material: in a glove box with the protection of argon, with synthetic graphite as a negative electrode, 23.5 g of the synthetic graphite, 0.375 g of calcium carboxymethylcellulose (CMC-Na), 0.625 g of butadiene styrene rubber (SBR), 0.5 g of the carbon black (SP) and 12.5 g of deionized water for mixing and dispersion, and then the negative electrode active material was prepared.

(3) An aluminum foil was coated with the prepared positive electrode active material, a copper foil was coated with the negative electrode active material; the aluminum foil and the copper foil were baked for 24 h at 80° C. and then rolled to prepare a positive electrode sheet 5 and a negative electrode sheet 6; and the positive electrode sheet 5, a diaphragm 7 and the negative electrode sheet 6 were stacked to form a stacked cell 1, wherein the positive electrode sheet 5 coated with the positive electrode active material faces one side of the diaphragm 7; and the negative electrode sheet 6 coated with the negative electrode active material faces the other side of the diaphragm 7.

(4) 18 g of epoxy resin A gel (base resin) and 9 g of epoxy resin B gel (hardening agent) were mixed to prepare a precursor of an encapsulating agent; then 0.1 g of a black coloring agent was added to prepare a mixed liquid; the stacked cell 1 was placed in a mold; an opening was reserved for liquid injection during the encapsulation of the encapsulating agent; the mold was placed in a vacuum environment for 30 min and then taken out after 30 min for still standing for 4 h; after still standing was finished, the liquid was injected for a battery with the injection quantity of 1.6 g (wherein an injected electrolytic solution contains 1 mol/L lithium hexafluorophosphate (LiPF₆) as lithium salt and ethylene carbonate (EC) and dimethyl carbonate (DMC) as a solvent, and a volume ratio of the ethylene carbonate (EC) and the dimethyl carbonate (DMC) is 1 to 1); and after liquid injection, the same encapsulating agent was employed for carrying out secondary encapsulation on the opening of the battery.

(5) The battery made in step (4) was subjected to still standing for 12 h in an ageing room at 50° C.; and after ageing, formation was carried out on the battery, wherein a formation method in this embodiment belongs to the prior art.

### Embodiment 3

An integrated packaging method for a portable energy storage device includes the following steps:

(1) Preparation of a positive electrode active material: in a glove box with the protection of argon, with lithium cobalt oxide as a positive electrode material, 47.5 g of the lithium cobalt oxide (LCO), 1 g of polyvinylidene fluoride (PVDF), 1 g of carbon black (SP), 0.5 g of a carbon nanotube (CNT) and 25 g of N-methylpyrrolidone (NMP) were weighed for mixing and dispersion, and then the positive electrode active material was prepared.

(2) Preparation of a negative electrode active material: in a glove box with the protection of argon, with synthetic graphite as a negative electrode, 23.5 g of the synthetic graphite, 0.375 g of calcium carboxymethylcellulose (CMC-Na), 0.625 g of butadiene styrene rubber (SBR), 0.5 g of the carbon black (SP) and 12.5 g of deionized water for mixing and dispersion, and then the negative electrode active material was prepared.

(3) An aluminum foil was coated with the prepared positive electrode active material, a copper foil was coated with the negative electrode active material, and the aluminum foil and the copper foil were baked for 24 h at 80° C. and then rolled to prepare a positive electrode sheet 5 and a negative electrode sheet 6; and a stack formed by the positive electrode sheet 5, the diaphragm 7 and the negative electrode sheet 6 was sequentially curled to form a roll cell 1, with the positive electrode sheet 5 being in the inner layer and the negative electrode sheet 6 being in the outer layer, wherein the positive electrode sheet 5 coated with the positive electrode active material faces one side of the diaphragm 7; and the negative electrode sheet 6 coated with the negative electrode active material faces the other side of the diaphragm 7.

(4) 15 g of thermally conductive silica gel A and 15 g of thermally conductive silica gel B were mixed to prepare a precursor of an encapsulating agent; then 0.1 g of a blue coloring agent was added for mixing to prepare a mixed liquid; a roll cell 1 was placed in a mold; an opening was reserved for liquid injection during the encapsulation of the encapsulating agent; the mold was placed in a vacuum environment for 30 min and then taken out after 30 min for still standing for 4 h; after still standing was finished, the liquid was injected for a battery with the injection quantity of 1.6 g (wherein an injected electrolytic solution contains 1 mol/L lithium hexafluorophosphate (LiPF₆) as lithium salt and ethylene carbonate (EC) and dimethyl carbonate (DMC) as a solvent, and a volume ratio of the ethylene carbonate (EC) and the dimethyl carbonate (DMC) is 1 to 1); and after liquid injection, the same encapsulating agent was employed for carrying out secondary encapsulation on the opening of the battery.

(5) The battery made in step (4) was subjected to still standing for 6 h in an ageing room at 80° C.; and after ageing, formation was carried out on the battery, wherein a formation method in this embodiment belongs to the prior art.

### Embodiment 4

An integrated packaging method for a portable energy storage device includes the following steps:

(1) a 5000 mAh cell purchased from Shandong Jinpin Energy Corporation was checked in voltage, internal resistance and appearance, wherein the voltage is 4.16 V, and the internal resistance is 15.23 mΩ;

(2) a 5 V and 1 A PCB mainboard purchased from Echuang Electronics Corporation was welded with a positive electrode and a negative electrode of the cell;

(3) 10 g of polycarbamate A and 10 g of polycarbamate B were mixed to prepare a mixed liquid;

(4) the welded cell and PCB were put in a mold, and then the mixed liquid was poured at a normal temperature (25° C.) for reaction for 240 min; and

(5) a prepared mobile power supply was checked in voltage, internal resistance and appearance, wherein through a check, the voltage is 5 V, and the internal resistance is 60.89 mΩ.

### Embodiment 5

An integrated packaging method for a portable energy storage device includes the following steps:

(1) a 5000 mAh cell purchased from Shandong Jinpin Energy Corporation was checked in voltage, internal resistance and appearance, wherein the voltage is 4.17 V; the internal resistance is 16.68 mΩ; and the purchased cell was encapsulated with an aluminum-plastic film;

(2) a 5 V and 2 A PCB mainboard purchased from Echuang Electronics Corporation was welded with a positive electrode and a negative electrode of the cell;

(3) 20 g of polycarbamate A and 20 g of polycarbamate B were mixed to prepare a mixed liquid;

(4) the welded cell and PCB were put in a mold, and then the mixed liquid was poured at 100° C. for reaction for 1 min; and

(5) a prepared mobile power supply was checked in voltage, internal resistance and appearance, wherein through a check, the voltage is 5 V, and the internal resistance is 65.76 mΩ.

### Embodiment 6

An integrated packaging method for a portable energy storage device includes the following steps:

(1) a 5000 mAh cell purchased from Shandong Jinpin Energy Corporation was checked in voltage, internal resistance and appearance, wherein the voltage is 4.17 V; the internal resistance is 16.63 mΩ; and the purchased cell was encapsulated with an aluminum-plastic film;

(2) a 5 V and 2 A PCB mainboard purchased from Echuang Electronics Corporation was welded with a positive electrode and a negative electrode of the cell;

(3) 20 g of polycarbamate A and 20 g of polycarbamate B were mixed to prepare a mixed liquid;

(4) the welded cell and PCB were put in a mold, and then the mixed liquid was poured at 50° C. for reaction for 20 min; and

(5) a prepared mobile power supply was checked in voltage, internal resistance and appearance, wherein through a check, the voltage is 5 V, and the internal resistance is 63.36 mΩ.

### Embodiment 7

An integrated packaging method for a portable energy storage device includes the following steps:

(1) a 5000 mAh cell purchased from Shandong Jinpin Energy Corporation was checked in voltage, internal resistance and appearance, wherein the voltage is 4.17 V; the internal resistance is 14.98 mΩ; and the purchased cell was encapsulated with an aluminum-plastic film;

(2) a 5 V and 1 A PCB mainboard purchased from Echuang Electronics Corporation was welded with a positive electrode and a negative electrode of the cell;

(3) 20 g of polycarbamate A and 20 g of polycarbamate B were mixed to prepare a mixed liquid;

(4) the welded cell and PCB were put in a mold, and then the mixed liquid was poured at a normal temperature for vacuum treatment for 720 min; and

(5) a prepared mobile power supply was checked in voltage, internal resistance and appearance, wherein through a check, the voltage is 5 V, and the internal resistance is 61.25 mΩ.

### Embodiment 8

An integrated packaging method for a portable energy storage device includes the following steps:

(1) a 5000 mAh cell purchased from Shandong Jinpin Energy Corporation was checked in voltage, internal resistance and appearance, wherein the voltage is 4.18V; the internal resistance is 16.56 mΩ; and the purchased cell was encapsulated with an aluminum-plastic film;

(2) a 5 V and 1 A PCB mainboard purchased from Echuang Electronics Corporation was welded with a positive electrode and a negative electrode of the cell;

(3) 20 g of polycarbamate A and 20 g of polycarbamate B were mixed to prepare a mixed liquid;

(4) the welded cell and PCB were put in a mold, and then the mixed liquid was poured at a normal temperature for vacuum treatment 30 s, and reaction was conducted for 10 min at 60° C. and

(5) a prepared mobile power supply was checked in voltage, internal resistance and appearance, wherein through a check, the voltage is 5 V, and the internal resistance is 73.66 mΩ.

### Embodiment 9

An integrated packaging method for a portable energy storage device includes the following steps:

(1) a 5000 mAh cell purchased from Shandong Jinpin Energy Corporation was checked in voltage, internal resistance and appearance, wherein the voltage is 4.18V; the internal resistance is 16.56 mΩ; and the purchased cell was encapsulated with an aluminum-plastic film;

(2) a 5 V and 1 A PCB mainboard purchased from Echuang Electronics Corporation was welded with a positive electrode and a negative electrode of the cell;

(3) 20 g of polycarbamate A and 20 g of polycarbamate B were mixed to prepare a mixed liquid, and then the mixed liquid was mixed with polyester fibers;

(4) the welded cell and PCB were put in a mold, and then the mixed liquid was poured at a normal temperature for vacuum treatment 30 s, and reaction was conducted for 10 min at 60° C.; and

(5) a prepared mobile power supply was checked in voltage, internal resistance and appearance, wherein through a check, the voltage is 5 V, and the internal resistance is 75.86 mΩ.

### Embodiment 10

An integrated packaging method for a portable energy storage device includes the following steps:

(1) a 5000 mAh cell purchased from Shandong Jinpin Energy Corporation was checked in voltage, internal resistance and appearance, wherein the voltage is 4.18V; the internal resistance is 19.58 mΩ; and the purchased cell was encapsulated with an aluminum-plastic film;

(2) a 5 V and 1 A PCB mainboard purchased from Echuang Electronics Corporation was welded with a positive electrode and a negative electrode of the cell;

(3) 20 g of silica gel A and 20 g of silica gel B were mixed to prepare a mixed liquid, and then the mixed liquid was mixed with polyester fibers;

(4) the welded cell and PCB were put in a mold, and then the mixed liquid was poured at a normal temperature for vacuum treatment 30 s, and reaction was conducted for 10 min at 60° C.;

(5) a prepared mobile power supply was taken out from the mold and then put in a dustfree environment, the surface of the mobile power supply was loaded with matte oil, and the mobile power supply was left for still standing for 10 min at 60° C. after being loaded with the matte oil; and

(6) the prepared mobile power supply was checked in voltage, internal resistance and appearance, wherein through a check, the voltage is 5 V, and the internal resistance is 82.71 mΩ.

### Embodiment 11

This embodiment is different from embodiment 10 in that the condition after matte oil loading in step (5) is changed in that: the mobile power supply was left for still standing for 10 h at 25° C.

### Embodiment 12

This embodiment is different from embodiment 9 in that the condition after matte oil loading in step (5) is changed in that: the mobile power supply was left for still standing for 1 min at 100° C.

### Embodiment 13

This embodiment is different from embodiment 10 in that the cell purchased in step (1) is replaced with the cell in embodiment 1.

### Embodiment 14

This embodiment is different from embodiment 9 in that 20 g of polycarbamate A and 20 g of polycarbamate B are replaced with 20 g of room temperature vulcanized silicone rubber A and 20 g of room temperature vulcanized silicone rubber B; and the remaining steps are the same.

### Embodiment 15

This embodiment is different from embodiment 9 in that (1) 20 g of polycarbamate A and 20 g of polycarbamate B are replaced with 20 g of photoresist SU-8; and (2) the welded cell and PCB were put in the mold, the mixed liquid was poured at a normal temperature for vacuum treatment for 30 s, a resultant was irradiated by ultraviolet light for 5 min at 60° C. The remaining steps are the same.

### Embodiment 16

This embodiment is different from embodiment 9 in that during preparation of the encapsulating agent, 0.5 g of titanium dioxide as an inorganic coloring agent was further added.

### Embodiment 17

This embodiment is different from embodiment 9 in that during preparation of the encapsulating agent, 0.5 g of phthalocyanine as an organic coloring agent was further added.

### Embodiment 18

This embodiment is different from embodiment 9 in that during preparation of the encapsulating agent, 1 g of aluminum hydroxide as an inorganic fire retardant was further added.

### Embodiment 19

This embodiment is different from embodiment 9 in that during preparation of the encapsulating agent, 1 g of trimethyl phosphate as an inorganic fire retardant was further added.

### Embodiment 20

This embodiment is different from embodiment 9 in that the encapsulating agent is 2 g of photocurable material TMP3EOTA (ethoxylated trimethylolpropane triacrylate), and a corresponding photoinitiator is 0.02 g of HMPP (2-hydroxy-2-methyl-1-phenyl-1-propanone).

### Embodiment 21

This embodiment is different from embodiment 9 in that during preparation of the encapsulating agent, 0.1 g of dilauryl thiodipropionate was further added.

### Embodiment 22

This embodiment is different from embodiment 9 in that during preparation of the encapsulating agent, 0.1 g of trihydroxyethyl methyl quaternary ammonium methyl sulfate was further added.

### Embodiment 23

This embodiment is different from embodiment 9 in that during preparation of the encapsulating agent, 0.01 g of calcium carbonate was further added.

### Embodiment 24

This embodiment is different from embodiment 9 in that during preparation of the encapsulating agent, 0.1 g of lauroyl glutamine was further added.

### Embodiment 25

This embodiment is different from embodiment 9 in that the surface of the mold or a product was coated with a layer of lubricant for facilitating demolding. The lubricant in this embodiment includes an inner lubricant, an outer lubricant and a surfactant. The inner lubricant may be stearic acid, c14-c18 fatty acid monoglyceride, a metallic soap or liquid paraffin. The outer lubricant may be paraffin, silicone oil or polyethylene wax.

### Embodiment 26

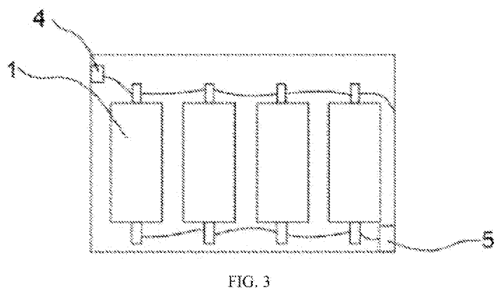

This embodiment is different from embodiment 4 in that as shown in FIG. 3, four cells are welded on the PCB and are arranged at an interval. The remaining steps are the same as embodiment 4.

### Embodiment 27

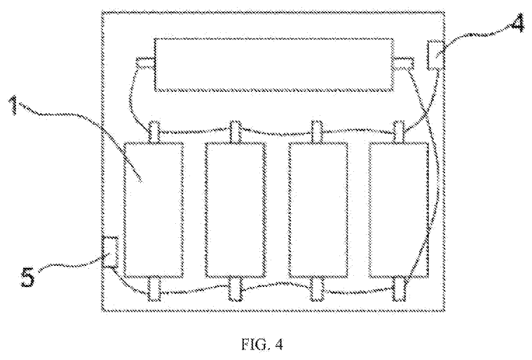

This embodiment is different from embodiment 4 in that as shown in FIG. 4, five cells are welded on the PCB with four cells being arranged on the PCB at an interval and the other cell being located at the end parts of the four cells, and then the PCB is put in the mold. The remaining steps are the same as embodiment 4.

### Embodiment 28

This embodiment is different from embodiment 1 in steps (3) and (4):

(3) an aluminum foil was coated with the prepared positive electrode active material, a copper foil was coated with the negative electrode active material, and the aluminum foil and the copper foil were baked for 24 h at 80° C. and then rolled to prepare a positive electrode sheet 5 and a negative electrode sheet 6; and the positive electrode sheet 5, a solid electrolyte PEO 7 and the negative electrode sheet 6 was sequentially stacked to form a stacked cell 1, with the positive electrode sheet 5 being in the inner layer and the negative electrode sheet 6 being in the outer layer, wherein the positive electrode sheet 5 coated with the positive electrode active material faces one side of the solid electrolyte 7; and the negative electrode sheet 6 coated with the negative electrode active material faces the other side of the solid electrolyte 7.

(4) 15 g of silica gel A and 15 g of silica gel B were mixed to prepare a precursor of an encapsulating agent; then 0.1 g of a purple coloring agent was added for mixing to prepare a mixed liquid; a roll cell 1 was placed in a mold; an opening was reserved for formation during the encapsulation of the encapsulating agent; the mold was placed in a vacuum environment for 30 min and then taken out after 30 min for still standing for 4 h; and after still standing was finished, the same encapsulating agent was employed for carrying out secondary encapsulation on the opening of the battery.

The above embodiments are only used to explain the technical solution of the present disclosure and shall not be construed as limitation. Although the present disclosure has been described in detail with respect to the previously described embodiments, it should be appreciated by one skilled in art, the technical solutions recorded in the embodiments may be still modified, or part of its technical features may be replaced with equivalents; and such modifications or substitutions do not deviate the nature of the technical solutions from the spirit and scope of the technical solutions of the various embodiments in the present disclosure.

What is claimed is:

1. An integrated packaging method for a portable energy storage device, comprising the following steps:
(1) preparing a roll cell or a stacked cell, specifically, coating a positive electrode current collector with a positive electrode active material, coating a negative electrode current collector with a negative electrode active material, carrying out rolling and drying to prepare a positive electrode sheet and a negative electrode sheet, and sequentially stacking the prepared positive electrode sheet, a solid electrolyte and the negative electrode sheet to form a stacked cell A; or sequentially stacking the prepared positive electrode sheet, a diaphragm and the negative electrode sheet to form a stacked cell B or to be curled to form a roll cell B;
(2) placing the prepared roll cell B or stacked cell B in a mold, injecting a precursor of an encapsulating agent for carrying out encapsulation, injecting an electrolyte, obtaining a cell after the precursor is polymerized, and then completing the encapsulation;
or placing the prepared stacked cell A in the mold, injecting the precursor of the encapsulating agent for carrying out encapsulation, obtaining a cell after the precursor is polymerized, and then completing the encapsulation;
or encapsulating the prepared roll cell B or stacked cell B with the aluminum-plastic film, the aluminum shell or the steel shell, injecting an electrolyte, then using the precursor of the encapsulating agent for carrying out encapsulation again to obtain the cell, and then completing the encapsulation;
or encapsulating the prepared stacked cell A with the aluminum-plastic film, the aluminum shell or the steel shell, then using the precursor of the encapsulating agent for carrying out encapsulation again to obtain the cell, and then completing the encapsulation;
wherein the encapsulating material comprises one or more of resin, silica gel and rubber, wherein the resin comprises thermosetting resin, and the thermosetting resin comprises epoxy resin or polydimethylsiloxane; or the encapsulating agent comprises a photocurable material; or the encapsulating agent comprises a photoinitiator and an encapsulating material.

2. The integrated packaging method for the portable energy storage device according to claim 1, wherein the obtained cell is fixed to a printed circuit board (PCB), the PCB is placed in the mold, and then the precursor of the encapsulating agent is continuously employed for packaging the cell.

3. The integrated packaging method for the portable energy storage device according to claim 1, wherein the thermosetting resin further comprises polymethyl methacrylate, polycarbamate, urea resin, melamine-formaldehyde resin, polyurethane and polyimide.

4. The integrated packaging method for the portable energy storage device according to claim 1, wherein the rubber comprises one-component room temperature vulcanized silicone rubber, double-component condense type room temperature vulcanized silicone rubber, double-component addition type room temperature vulcanized silicone rubber, one-component room temperature vulcanized and cyclized rubber, double-component room temperature vulcanized and cyclized rubber and double-component room temperature vulcanized ethylene propylene rubber.

5. The integrated packaging method for the portable energy storage device according to claim 1, wherein the encapsulating agent further comprises one or more of a coloring agent, a fire retardant, a toughening agent, an antioxidant, an antistatic agent, a foaming agent and a filler.

6. The integrated packaging method for the portable energy storage device according to claim 5, wherein the coloring agent comprises an inorganic coloring agent and an organic coloring agent.

7. The integrated packaging method for the portable energy storage device according to claim 6, wherein the inorganic coloring agent comprises titanium dioxide, ferric oxide, zinc oxide, chromate, tin salt, mercury or cadmium.

8. The integrated packaging method for the portable energy storage device according to claim 5, wherein the fire retardant comprises an organic fire retardant or an inorganic fire retardant.

9. The integrated packaging method for the portable energy storage device according to claim 5, wherein the toughening agent comprises polyester fibers, polyamide fibers, polyvinyl alcohol fibers, polyacrylonitrile fibers, polypropylene fibers or polyvinyl chloride fibers.

10. The integrated packaging method for the portable energy storage device according to claim 1, wherein the encapsulating agent, in which the precursor is charged, is placed in vacuum for treatment for 0-720 min and then conducts reaction for 1-240 min at 25-100° C.
